(19) United States
(12) Patent Application Publication
(10) Pub. No.: US 2010/0044924 A1
(43) Pub. Date: Feb. 25, 2010

(54) CANDLE REFILL KIT AND METHOD OF USE

(76) Inventor: DANIEL S. CAP, Maryville, TN (US)

Correspondence Address: PAULEY PETERSEN & ERICKSON, 2800 WEST HIGGINS ROAD, SUITE 365, HOFFMAN ESTATES, IL, 60169, US

(21) Appl. No.: 12/568,559

(22) Filed: Sep. 28, 2009

Related U.S. Application Data
(63) Continuation-in-part of application No. 11/111,026, filed on Apr. 21, 2005.

(51) Int. Cl. B29C 67/00; B65D 30/16; B65D 33/10

(52) U.S. Cl. 264/489; 383/104; 383/7

(57) ABSTRACT

A candle refill kit useful for preparing home made candles includes a disposable microwaveable container and a microwaveable candlewax composition. The candlewax composition is microwave heated in the microwaveable container to an elevated temperature sufficient to initiate pouring of the candlewax composition. The candlewax composition is then poured from the microwaveable container into a candle mold (to make a stand-alone candle) or a candle container (to make a container candle).

### RELATED APPLICATIONS

This patent application is a continuation-in-part of U.S. patent application Ser. No. 11/111,026, filed on 21 Apr. 2005, the disclosure of which is incorporated by reference.

### FIELD OF THE INVENTION

This invention is directed to a candle refill kit which can be used to make a candle in as little as two steps, and a corresponding method of use.

### BACKGROUND OF THE INVENTION

Candlemaking by individuals is a hobby that requires skill, time and precision. Conventional candlemaking kits for making paraffin wax-based and other candles include separate quantities of various wax ingredients, oils, scenting agents, coloring agents and the like. The individual candlemaker slowly heats the wax ingredients in a double boiler, on a conventional stove to a carefully selected temperature, adds and mixes the remaining ingredients at selected time intervals, then pours the resulting mixture into individual containers (for container candles) or molds (for stand-alone candles). Failure to carefully follow the procedures can result in candles with uneven color, inadequate scent, uneven burning and/or undesirable appearance. Overheating, or uneven heating, can result in burns, fires, and related hazards.

One example of a candlewax commercially sold for candle kits is a 10-lb slab of paraffin wax mixed with color and fragrance, sold by Endless Possibilities of Oklahoma City, Okla. under the trade name CRAFTY CANDLES. This wax must be melted in a boil bag or double boiler before being poured into a candle mold, jar or container. Accidental overheating can result in fire.

While candlemaking by individuals is less expensive than purchasing ready-made candles, many individuals practice candlemaking primarily for enjoyment and fun. Others seek to minimize the cost of obtaining candles without spending substantial time and effort. Thus, there is a demand for candle kits which are simpler and safer to use.

U.S. Pat. No. 3,744,956, issued to Hess, discloses a candlemaking kit including shaped slugs of wax having different colors. The shaped slugs of wax are inserted into a container equipped with a wick. Molten wax is then poured into the container to fill the spaces between the wax slugs, wick and container wall.

U.S. Pat. No. 4,855,098, issued to Taylor, discloses a method of forming candles from hard, pre-formed pieces of paraffin wax composition. The pre-formed wax pieces are submerged in water at 100-120° F. to soften the wax. The wax pieces are removed from the water, and are combined with a wick and each other while still soft, to make a candle.

One feature often associated with simplified candlemaking kits is that the candles thus formed are obviously different from most other candles. The simplified kits often do not result in candles having a solid, uniform appearance. There is thus a need for a candlemaking kit which, with minor effort, can be used to make candles that are visually indistinguishable from factory made candles purchased in stores, and from home made candles made using more elaborate techniques.

### SUMMARY OF THE INVENTION

The present invention is directed to a candle refill kit and associated method of making candles. The candle refill kit includes a disposable microwaveable container and a microwaveable candlewax composition.

In one embodiment, the candle refill kit includes a disposable microwaveable container, a measured amount of microwaveable candlewax composition in the container and one or more wicks. The wicks can be properly selected and/or engineered for compatible burning with the wax composition. The disposable microwaveable container may contain enough candlewax composition to make one candle of a predetermined size, or may contain enough candlewax composition to make a predetermined number of candles. The candlewax composition may include all of the candlewax ingredients blended together, and includes all of the essential ingredients of a candle except for a wick and (where applicable) a candle container. Alternatively, scenting agents and/or coloring agents may be provided in one or more separate packets.

To use the kit, the candlemaker heats the disposable microwaveable container including the candlewax composition in a microwave oven for a time sufficient to melt the candlewax composition. The molten candlewax composition is then poured into one or more candle molds, each equipped with a wick (to make stand-alone candles) or one of more candle containers, each equipped with a wick (to make container candles). Separate packets of scenting and/or coloring agents may be added to the candlewax and mixed before or after the molten wax is poured. The resulting candles have a uniform appearance and composition, similar to or better than factory-made candles purchased in stores, and home made candles made using more complex conventional methods.

In another embodiment, the candle refill kit includes a disposable microwaveable container and a measured amount of microwaveable candlewax composition in a solid form separate from the container. The measured amount of candlewax composition may be enough to make just one candle, or a predetermined number of candles, and may be in a packet. The candlewax composition includes all of the candlewax ingredients blended together. Alternatively, scenting agents and/or coloring agents may be provided in one or more separate packets. To use the kit, the candlemaker transfers the solid candlewax composition into the disposable microwaveable container, and then follows the method steps described for using the first embodiment of the candle refill kit.

The features and advantages of the candle refill kit using microwaveable candlewax may include some or all of the following. First, the microwaveable candlewax is easier and safer to process than conventional paraffin wax which requires a stove-top double boiler. Paraffin wax is subject to ignition when overheated. Second, making candles from the candle refill kit is less expensive than purchasing new candles. Third, candles made using the candle refill kit may be of higher quality than stove-top formed and store-bought candles.

Fourth, the microwaveable candlewax can be formed using renewable resources, such as vegetable waxes. Fifth, microwaveable candlewax compositions including vegetable wax are easier to clean from hard surfaces, clothing and skin than paraffin wax, and can typically be removed using soap and water. Sixth, the candle refill kit provides a simplified candlemaking process using pre-measured amounts of various candlewax ingredients. The emotional fulfillment of making one's own quality candles can thus be experienced by a larger number of people.

The foregoing and other features and advantages of the invention will become further apparent from the following detailed description.

### BRIEF DESCRIPTION OF THE DRAWINGS

FIG. 1 is a perspective view of a first embodiment of a candle refill kit of the invention.

FIG. 2 is a perspective view of a second embodiment of a candle refill kit of the invention.

FIG. 3 illustrates the candle refill kit of FIG. 1 with a particularly suitable lid and vented cover.

FIG. 4 is a front view of a third embodiment of a candle refill kit of the invention.

FIG. 5 is a side sectional view taken along the line 5-5 in FIG. 4.

FIG. 6 is a side view of the candle refill kit of FIG. 4.

FIGS. 7 and 8 are front views of candle refill kits similar to that of FIG. 4 with variations.

### DEFINITIONS

As used herein, the term “plant-based wax” refers to a plant-based substance which has a solid, wax-like consistency at ambient conditions (22° C., 50% relative humidity). The term includes vegetable oils which have been partially or fully hydrogenated or fractionated to generate a solid, wax-like consistency, and plant-based substances such as carnauba wax and candelilla wax which have a solid, wax-like consistency without requiring hydrogenation.

As used herein, the term “paraffin-based wax” refers to waxes derived from a class of all aliphatic hydrocarbons characterized by a straight or branched hydrocarbon chain, having a molecular formula CₙH₂ₙ₊₂, and a high enough molecular weight to produce a melting point of about 33-100° C., suitably about 40-65° C. Paraffin waxes also have a solid, wax-like consistency at ambient conditions (22° C., 50% relative humidity). Paraffin waxes typically include a mixture of high molecular weight aliphatic hydrocarbons, which mixture possesses these properties.

As used herein, “hydrogenated vegetable oil” encompasses partially and fully hydrogenated vegetable oils.

As used herein, “vegetable oil” includes any plant-based oil. Vegetable oils may be naturally occurring or processed, and may be solid or liquid at ambient conditions (72° F., 50% relative humidity). The term includes plant-based oils whose carbon-carbon double bonds are unsaturated, partially or fully saturated.

As used herein, “partially hydrogenated vegetable oil” includes any plant-based oil which has been partially hydrogenated. The term “partially hydrogenated vegetable oil” also includes mixtures of partially hydrogenated vegetable oil and fully hydrogenated vegetable oil. Such mixtures are by definition, partially hydrogenated with an intermediate level of hydrogenation. Similarly, the term “partially hydrogenated vegetable oil” includes mixtures of partially hydrogenated vegetable oil and vegetable oil which has not been hydrogenated, and mixtures of fully hydrogenated and unhydrogenated vegetable oil.

As used herein, “fully hydrogenated vegetable oil” includes any plant-based oil which has been fully hydrogenated. Fully hydrogenated vegetable oils typically have iodine values between zero and five.

As used herein, “fractionated vegetable oil” includes any vegetable oil which has been processed by fractionation. Fractionation removes the solid, wax-like components from the liquid components of vegetable oil by controlled crystallization and separation. Fractionation techniques may involve the use of solvents or dry processing.

As used herein, “lipid” is an inclusive term for fats and fat-derived materials. It includes all substances that are 1) relatively insoluble in water but soluble in organic solvents, 2) related either actually or potentially to fatty acid esters, fatty alcohols, sterols, waxes, etc., and 3) utilizable by animal organisms.

As used herein, “iodine value” is the number of grams of iodine that an unsaturated compound or blend will absorb in a given time under arbitrary conditions. A low iodine value implies a high level of saturation, and vice versa. The iodine value can be determined by the WIJS method of the American Oil Chemists' Society (A.O.C.S. Cd 1-25).

As used herein, “coloring agent” refers to conventional dyes, pigments, and other ingredients whose purpose is to impart color to a candlewax composition.

As used herein, “scenting agent” refers to any additive for a candlewax composition which is intended to release a selected aroma prior to or during burning of a candle made from the candlewax composition. Examples of scenting agents include without limitation scented oils, essential oils and other liquid fragrances.

### DETAILED DESCRIPTION OF THE PRESENTLY PREFERRED EMBODIMENTS

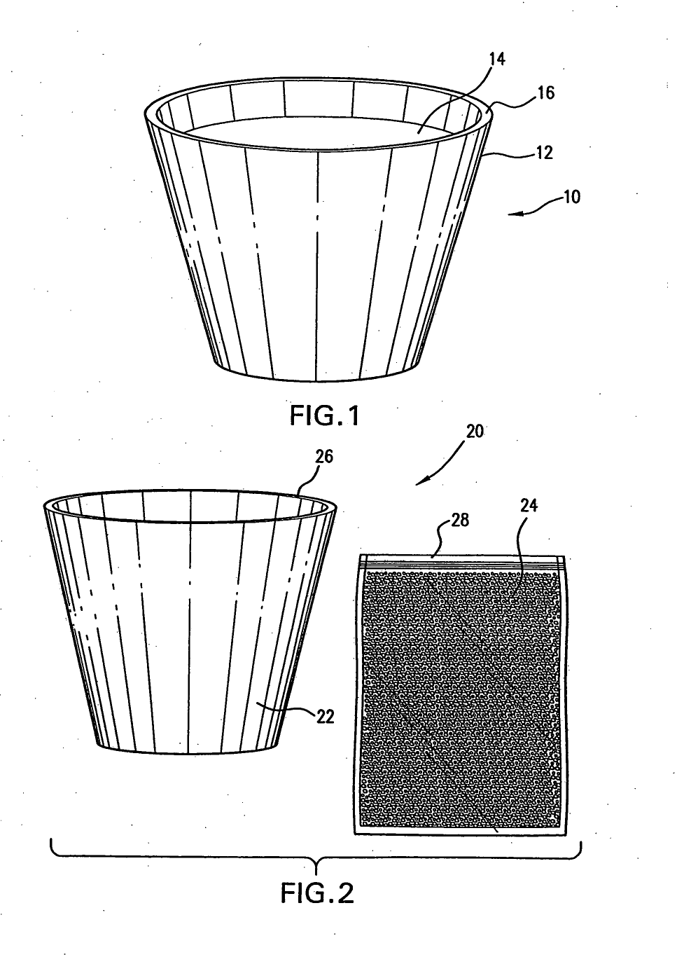

FIG. 1 illustrates a candle refill kit 10 of the invention which includes a disposable microwaveable container 12 and a predetermined amount of microwaveable candlewax composition 14 in the container 12. FIG. 2 illustrates a candle refill kit 20 of the invention which includes a disposable microwaveable container 22 and a predetermined amount of granules, flakes, beads or pastilles (collectively “particles”), block or slab of microwaveable candlewax composition 24 in a plastic bag 28 or other packet separate from the container 22.

One feature which makes the invention possible is the use of a microwaveable candlewax composition. The phrase “microwaveable candlewax composition” refers to a candlewax composition whose ingredients can be substantially transformed (preferably, entirely transformed) from a solid state to a molten state in a microwave oven. Conventional (i.e., non-microwaveable) candlewax compositions include primary amounts of paraffin wax ingredients. Paraffin waxes are typically not responsive to microwaves, and generally do not melt in a microwave oven. In one embodiment of the invention, the candlewax composition includes an operable amount of microwaveable ingredients in addition to paraffin wax, such that heating of the microwaveable ingredients in turn melts the paraffin wax. Alternatively, a non-conventional, microwaveable paraffin wax can be used.

Candlewax compositions useful in the kit of the invention should include enough microwaveable ingredients to melt remaining ingredients. The composition may include about 25-100% by weight microwaveable ingredients, or about 50-100% by weight microwaveable ingredients, or about 75-100% by weight microwaveable ingredients, or about 90-100% by weight microwaveable ingredients. “Microwaveable ingredients” include ingredients which can be transformed from a solid state to a molten state due to interaction with, and heating by microwaves, as well as ingredients which exist in a liquid state at ambient temperature, and are heated by microwaves. The amount of microwaveable ingredients should be high enough that the candlewax composition as a whole behaves as a microwaveable candlewax composition, meaning that it transforms to a molten state in a microwave oven. This means that essentially all of the candlewax ingredients melt either a) due to interaction with, and heating by microwaves, or b) due to interaction with other ingredients which, in turn, are heated by microwaves.

Microwaveable candlewax compositions include without limitation waxes and wax ingredients based on lipids. Lipids, as described below, are typically microwaveable. Examples of waxes based on lipids include plant-based waxes and animal-based waxes. These materials include any plant-based or animal-based substance which has a solid, wax-like consistency at ambient conditions. The lipid-based wax may have an iodine value of about 0-150.

Examples of plant-based waxes include plant-based substances such as carnauba wax, candelilla wax and rice bran wax which have a wax-like consistency without requiring hydrogenation. Examples also include palm wax, cocoa butter, coconut oil, and all oils having a naturally high degree of saturation. Other examples include partially and fully hydrogenated vegetable oils (collectively “hydrogenated vegetable oils”) having an iodine value of about 0-100, suitably about 10-90, particularly about 15-80 and desirably about 20-75. A fully-hydrogenated vegetable oil may have an iodine value of about 0-5. Generally, the melting point of a vegetable oil increases as the level of hydrogenation increases and the iodine value decreases. The hydrogenation process adds hydrogen atoms to the carbon-carbon double bonds in unsaturated fatty acids. In addition to higher melting points, hydrogenation leads to higher solid fat content and longer shelf life. Partially hydrogenated vegetable oils typically have a higher iodine value, and are useful in applications (e.g., container candles) where lower melting points are desired.

The plant-based wax can also be a fractionated vegetable oil. Fractionation removes the solid, wax-like components from the liquid components of vegetable oil by controlled crystallization and separation. Fractionation techniques involve the use of solvents or dry processing. The effect of hydrogenation or fractionation is to provide a vegetable oil with a sufficiently high degree of saturation to perform as a wax having a desired melting point and other properties.

The hydrogenated or fractionated vegetable oil can be derived from any plant-based oil. Examples include without limitation cottonseed oil, sunflower oil, canola oil, peanut oil, soybean oil, safflower oil, corn oil, palm oil, olive oil, coconut oil, palm kernel oil, almond oil, jojoba oil, avocado oil, sesame oil, castor oil, and combinations thereof. The hydrogenated or fractionated vegetable oil may be derived from one or more vegetable oils having the same or different levels of saturation. Vegetable oils derived from natural sources typically include one or more triglycerides as a major component, lesser amounts of diglycerides and monoglycerides, and very minor amounts of free fatty acids. A triglyceride is an ester compound of glycerol linked to three fatty acids, and has the following general formula:

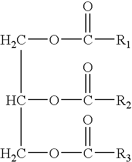

wherein R₁, R₂ and R₃ are fatty acid chains and may be the same or different.

A diglyceride is an ester compound of glycerol linked to two fatty acid chains. A monoglyceride is an ester composed of glycerol linked to one fatty acid chain. A free fatty acid is an unattached fatty acid in a vegetable oil, most commonly stearic acid and/or palmitic acid.

The hydrogenated vegetable oil can be partially or fully hydrogenated using known techniques for chemically adding hydrogen gas to a liquid vegetable oil in the presence of a catalyst. The process converts some or all of the unsaturated carbon-carbon double bonds in the vegetable oil molecules to single carbon-carbon bonds, thereby increasing the level of saturation. The degree of hydrogenation reflects the total number of double bonds which are converted. The hydrogenation may cause partial or total saturation of the double bonds in any of the vegetable oil components, including triglycerides, diglycerides, monoglycerides and free fatty acids. Partial hydrogenation may relocate some of the double bonds to new locations, e.g., from a cis isomeric configuration to a trans isomeric configuration. Sufficient hydrogenation typically causes the vegetable oil to assume a solid or semi-solid state at ambient temperature (e.g., 22° C.).

The lipid-based wax may be an acetylated plant-based wax. Acetylated plant-based waxes are described in U.S. Pat. No. 7,510,584, issued 31 Mar. 2009 to Daniel S. Cap, the disclosure of which is incorporated by reference.

The acetylated plant-based wax includes an acetylated vegetable wax, namely an acetylated glyceride with or without an additional (non-acetylated) plant-based wax. The term “acetylated plant-based wax” collectively refers to the acetylated glyceride and the optional plant-based wax. The plant-based wax component of the acetylated plant-based wax can be any of the plant-based waxes described above.

The acetylated glyceride can be derived from one or more glycerides of unhydrogenated vegetable oil, partially hydrogenated vegetable oil or fully hydrogenated vegetable oil. Suitably, the glycerides used for acetylation are partially or fully hydrogenated and have a collective iodine value of about 0-80, suitably about 0-50, particularly about 0-25, desirably about 0-10. The glycerides may be fully hydrogenated with an iodine value of about 0-5, for optimal chemical stability.

The acetylated glyceride may be formed by acetylation of any plant-based glycerides. Examples of suitable plant-based glycerides include without limitation glycerides derived from unsaturated, partially or fully saturated cottonseed oil, sunflower oil, canola oil, peanut oil, soybean oil, safflower oil, corn oil, palm oil, olive oil, coconut oil, palm kernel oil, almond oil, jojoba oil, avocado oil, sesame oil, castor oil, and combinations thereof. Palm oil is suitable for acetylation because it converts readily to acetylated palm oil using the processes described below, leaving relatively less unreacted chemicals. Fully saturated palm oil is desirable because the resulting acetylated palm oil is chemically stable and does not oxidize significantly. Various levels of saturation may be naturally occurring or may be achieved by hydrogenation or fractionation as described above.

The acetylation reaction can be accomplished in two steps. First, the vegetable oil (saturated to an appropriate level) can be reacted with glycerol to form a mixture of monoglyceride and diglyceride molecules. The following reaction is exemplary:

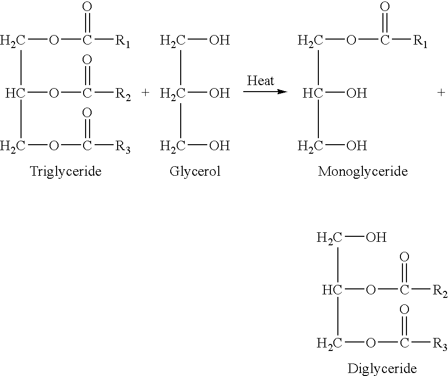

The above reaction may proceed in a mixing kettle, suitably a closed vessel, at a temperature high enough to melt the unsaturated, partially or fully saturated vegetable oil. Suitable temperatures may range from about 50-130° C., particularly about 80-120° C. A suitable catalyst may be employed.

The amount of monoglycerides and diglycerides obtained may be varied by increasing or decreasing the amount of glycerol in the reaction mixture relative to the unsaturated, partially or fully saturated vegetable oil. Equimolar quantities of triglyceride and glycerol favor the production of roughly equal amounts of monoglyceride and diglyceride. Higher levels of glycerol favor the production of more monoglyceride and less diglyceride. Lower levels of glycerol favor the production of more diglyceride. Much lower levels of glycerol (i.e., less than one mole of glycerol per two moles of triglyceride) favor the production of diglyceride and unreacted triglyceride.

Distilled monoglycerides, and mixtures of monoglycerides and diglycerides, are commercially available. One suitable mixture, containing roughly equal amounts of monoglyceride and diglyceride derived from soybean oil, is available from Bunge under the trade name ESTRIC.

Second, the monoglyceride and diglyceride molecules can be reacted with acetic anhydride to form acetylated monoglyceride and diglyceride molecules. The following reaction is exemplary:

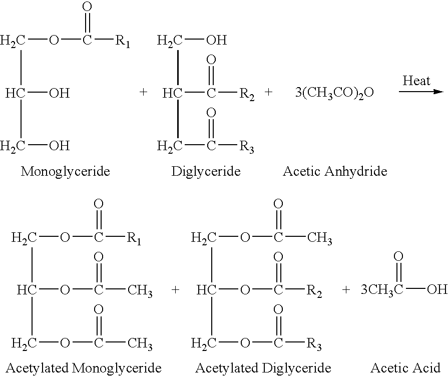

The second reaction step can proceed at a temperature high enough to soften and/or melt the glyceride components. For instance, the second reaction can proceed at a temperature of about 50-130° C., suitably about 80-120° C. The foregoing exemplary reaction achieves complete acetylation of monoglyceride and triglyceride molecules using a stoichiometric amount of acetic anhydride. Partial acetylation can be achieved using lower amounts of acetic anhydride. Following the second reaction step, the acetic acid and unreacted acetic anhydride can be washed away using water.

Other chemical processes can also be used to produce the acetylated glyceride, provided that the end product is an acetylated monoglyceride, or mixture of acetylated monoglyceride and acetylated diglyceride.

The degree of acetylation is the percentage of hydroxyl (—OH) linkages on the monoglyceride and diglyceride molecules that are converted to esters via acetylation. Each monoglyceride molecule has two hydroxyl groups available for conversion. Each diglyceride molecule has one hydroxyl group available for conversion. The degree of acetylation for the collective mixture of monoglyceride and diglyceride molecules influences the amount of flexibility that the acetylated glyceride contributes to the wax composition. Higher degrees of acetylation lead to higher flexibility and less rigidity. The degree of acetylation of the acetylated glyceride may range from about 10-100%, and is suitably about 30-85%, particularly about 45-75%.

The acetylated glyceride may contain at least about 40% by weight acetylated monoglyceride, suitably about 40-100% by weight acetylated monoglyceride and about 0-60% by weight acetylated diglyceride. In particular, the acetylated glyceride may contain about 45-95% by weight acetylated monoglyceride and about 5-55% by weight acetylated diglyceride.

Acetylated monoglycerides, and mixtures of acetylated monoglycerides and acetylated diglycerides, are available commercially. One source of acetylated monoglycerides, derived from fully hydrogenated palm oil, is available from Danisco Co. under the trade name GRINDSTED ACETAM 50-00PK. Another source, derived from fully hydrogenated soybean oil, is available from Quest Co. under the trade name MYVACET 5-07. Both products have a degree of acetylation of about 50%.

The acetylated plant-based wax may include about 0-95% by weight of the plant-based wax and about 5-100% by weight of the acetylated glyceride, suitably about 15-80% by weight of the plant-based wax and about 20-85% by weight of the acetylated glyceride, particularly about 30-65% by weight of the plant-based wax and about 35-70% by weight of the acetylated glyceride.

The lipid-based wax composition may contain about 0-100% plant-based wax (inclusive of acetylated plant-based wax, if any), suitably at least about 25% by weight plant-based wax, or about 50-98% by weight or about 60-95% by weight, or about 70-90% by weight, or about 60-80% by weight.

The lipid-based wax composition may also contain one or more polyol fatty acid partial ester components. Polyols which can be used to form the fatty acid partial esters include at least two and, preferably, at least three hydroxy groups per molecule (also referred to as “polyhydric alcohols”). Typically, the polyols have no more than 6 hydroxy groups per molecule and include up to 10 carbon atoms and more commonly no more than 6 carbon atoms. Examples of suitable aliphatic polyols include glycerol, alkylene glycols (e.g., ethylene glycol, diethylene glycol, triethylene glycol and neopentylglycol), pentaerythritol, trimethylolethane, trimethylolpropane, sorbitan and sorbitol. Suitable alicyclic polyols include cyclohexanediols and inositol as well as natural cyclic polyols such as glucose, galactose and sorbose.

The polyol fatty acid partial esters have one or more unesterified hydroxyl groups with the remaining hydroxy groups esterified by a fatty acyl group. The fatty acyl groups (“—C(O)R”) in the partial esters include an aliphatic chain (linear or branched) and typically have from 14 to 30 carbon atoms.

Fatty acid partial esters of polyols which include no more than about 6 carbon atoms and have three to six hydroxy groups per molecule, such as glycerol, pentaerythritol, trimethylolethane, trimethylolpropane, sorbitol, sorbitan, inositol, glucose, galactose, and/or sorbose, are suitable. Glycerol and/or sorbitan partial esters are examples of polyol fatty acid partial esters.

Fatty acid monoesters of polyols are suitable for use. Suitable examples include glycerol monoesters, e.g., glycerol monostearate, glycerol monopalmitate, and/or glycerol monooleate, and/or sorbitan monoesters, e.g., sorbitan monostearate, sorbitan monopalmitate, and/or sorbitan monooleate. Monoesters which are produced by partial esterification of a polyol with a mixture of fatty acids derived from hydrolysis of a triacylglycerol stock are also suitable. Examples include monoglycerol esters of a mixture of fatty acids derived from hydrolysis of a partially or fully hydrogenated vegetable oil, e.g., fatty acids derived from hydrolysis of fully hydrogenated soybean oil.

Propylene glycol monoesters are particularly suitable for use in lipid-based wax compositions according to the invention. Monoglycerides and diglycerides are also suitable. Other examples of suitable polyol fatty acid partial esters include without limitation di- and/or triesters of higher polyols, e.g., di- and/or triesters of a polyol having 5 hydroxy groups, such as sorbitan. For example, the lipid-based wax composition may include one or more sorbitan triesters of fatty acids having 16 to 18 carbon atoms, e.g., sorbitan tristearate, sorbitan tripalmitate, sorbitan trioleate, and mixtures including one or more of these triesters.

The polyol fatty acid partial ester component may constitute about 0-100% by weight of the lipid-based candlewax composition, suitably about 1-50% by weight, or about 10-35% by weight, or about 20-30% by weight.

The lipid-based candlewax composition may also include one or more free fatty acids. Examples of free fatty acids include without limitation lauric acid, myristic acid, palmitic acid, stearic acid, arachidic acid, palmitoleic acid, oleic acid, gadoleic acid, linoleic acid, linolenic acid and combinations thereof. When used, the free fatty acid component may constitute about 1-50% by weight of the plant-based candlewax composition, suitably about 3-25% by weight, or about 5-10% by weight.

The lipid-based wax composition may also include a scenting agent in an amount of up to about 50% by weight, suitably about 0.1-15% by weight, or about 1-10% by weight, or about 2-6% by weight. Examples of scenting agents include without limitation essential oils and artificial fragrances. Specific examples include without limitation sandalwood oil, civet oil, cedarwood oil, patchouli oil, bergamot oil, germanium oil, rose oil, citronella oil, and the like. Other liquid scenting agents include without limitation eugenol, geraniol, geranyl acetate, isoeugenol, isobornyl acetate, linalyl acetate, linalool, methyl ethyl ketone, methylionone, phenylethyl alcohol, and various other compounds of aldehydes, ketones, esters, alcohols, terpenes or the like. The scenting agent may be an insect repellent such as citronella or a therapeutic agent such as menthol or eucalyptus.

The lipid-based wax composition may also include other optimal wax ingredients, including without limitation, beeswax, montan wax, paraffin wax, and other conventional waxes. When used, these other wax ingredients typically do not constitute more than about 25% of the plant-based wax composition. Conventional dyes, pigments and other coloring agents may be added at up to about 8% by weight, suitably about 0.1-3% by weight.

The lipid-based wax composition may be composed of ingredients selected to provide a melting point of about 30-85%, suitably about 35-65° C., or about 40-55° C. The ingredients of the wax composition can be added individually or together to a melt blender and mixed at about 50-95° C., suitably about 55-85° C. until a uniform wax composition is obtained. Any conventional mixing equipment can be employed. The resulting plant-based wax composition is useful in a variety of candles.

The microwaveable candlewax composition may also include ingredients which are not independently microwaveable, but which melt in a microwave oven due to the presence of microwaveable ingredients. Ingredients which are not independently microwaveable may constitute about 0-75% by weight of the microwaveable candlewax composition, suitably no more than about 50% by weight, or no more than about 25% by weight, or no more than about 10% by weight, or substantially 0% by weight. Ingredients which are not independently microwaveable do not absorb microwave energy. Such ingredients include without limitation conventional paraffin waxes having an average carbon number of about 18-40, suitably about 22-36. These ingredients can be melted in a microwave oven by means of conductive heat transfer by other ingredients which absorb and are heated by microwaves. Thus, the inclusion of nonmicrowaveable ingredient(s) in the candlewax composition is contingent upon the presence of enough microwaveable ingredient(s) to render the overall candlewax composition microwaveable.

The term “disposable microwaveable container” refers generally to any relatively inexpensive container which can be discarded or recycled after a single use, and which can be used for heating and holding molten candlewax having a temperature of at least about 30° C., suitably about 50-95° C., particularly about 55-80° C. The disposable microwaveable container may be formed of a relatively inexpensive thermoplastic polymer having a melting point of at least about 105° C., which is significantly higher than the highest temperature achieved by molten candlewax in the container. Suitable thermoplastic materials include without limitation polypropylene, high density polyethylene, medium density polyethylene, linear low density polyethylene, branched low density polyethylene, some other polyolefin homopolymers and copolymers and other plastic materials. If the melting temperature of the disposable container is too low, or too close to the highest temperature achieved by the molten candlewax, the container may rupture and/or melt during heating of the candlewax in the disposable container.

Other disposable container materials can also be used, but are less preferred. Certain paper containers may contain the molten wax. However, paper containers are less sturdy and may not have sufficient insulative properties to prevent user discomfort when the container holding the molten wax is lifted. Disposable glass containers may be used. Disposable metal containers are more expensive, and may reflect or otherwise interfere with the microwaves.

The disposable microwaveable container may have a rectangular, cylindrical or semi-conical configuration, or another suitable shape. The disposable containers 12 and 22 illustrated in FIGS. 1 and 2 have a semi-conical cup-like configuration. The container walls 16 and 26 should be thick enough and sturdy enough to provide a rigid container with minimal bending when the container is lifted, and to insulate a user's hand from molten wax within the disposable container. Depending on the size of the disposable container, the container wall(s) may have a thickness of about 0.025 inch to about 0.250 inch, suitably about 0.050 inch to about 0.150 inch. Alternatively, the container may be in the form of a flexible bag.

In order to minimize unwanted spilling of molten wax, the disposable microwaveable container should have an internal volume which is about 10-20% larger than the volume of wax within the container. The size of the disposable microwaveable container may vary depending on the size and number of candle(s) to be made from the wax in the disposable container. Also, the disposable microwaveable container should not be so small or so large that handling the disposable container or pouring the molten wax becomes difficult. For instance, the disposable microwaveable container may have an internal volume of about 0.5 to about 80 ounces, suitably about 2 ounces to about 32 ounces, or about 4 ounces to about 16 ounces. Each wax-filled disposable container can be used to make from 1-20 candles, suitably from 1-10 candles, particularly from 1-4 candles.

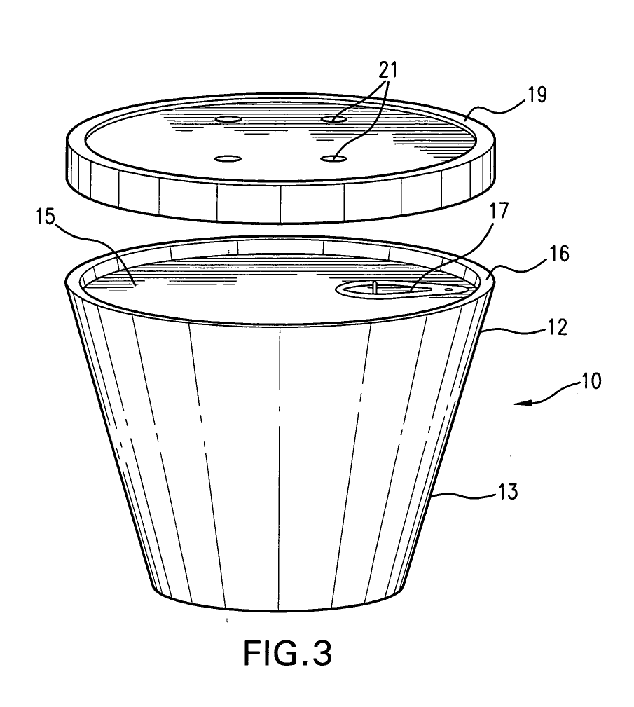

In one embodiment, the disposable microwaveable container 12 may be configured as illustrated in FIG. 3, with a lower cup portion 13, a removable sealed lid 15 formed of plastic or metal, and a pop-up tab 17 anchored to the sealed lid 15. A removable plastic outer cover 19 having openings 21 initially covers the sealed lid 15. When the candle refill kit is used, the outer cover 19 is temporarily removed and the sealed lid 15 is peeled away from the pre-filled container 12 with the aid of pop-up tab 17. The outer cover 19 is then re-installed. When the microwaveable container 12 is being heated, the openings 21 prevent pressure build-up in the container by allowing minimal escape of vapors. The outer cover 19 prevents boil-over of the wax composition while retaining most of any scenting agents within the container 12.

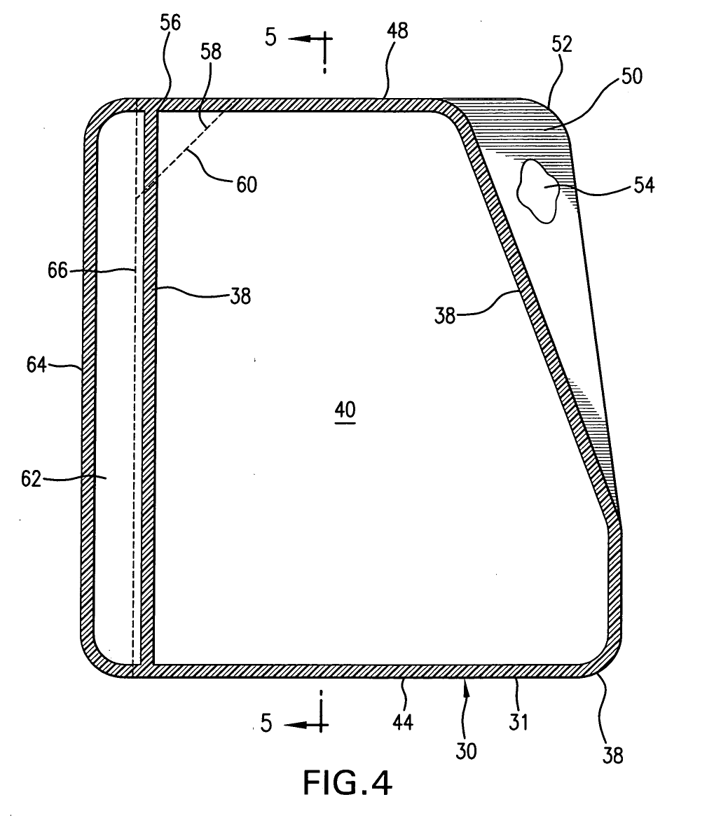

FIGS. 4-6 illustrate a candle refill kit 30 including a pre-filled microwaveable bag 31 that can also be used as a microwaveable heating and pouring container, thereby eliminating the need to transfer the microwaveable candlewax composition 14 from a separate package or bag into a microwaveable pouring container. The microwaveable bag 31 is suitably a high temperature-resistant flexible plastic bag that can withstand microwave temperature conditions. The microwaveable bag 31 may have a layer structure similar to retort bags and pouches sometimes used to sterilize, store and cook food, and may be a retort bag or pouch.

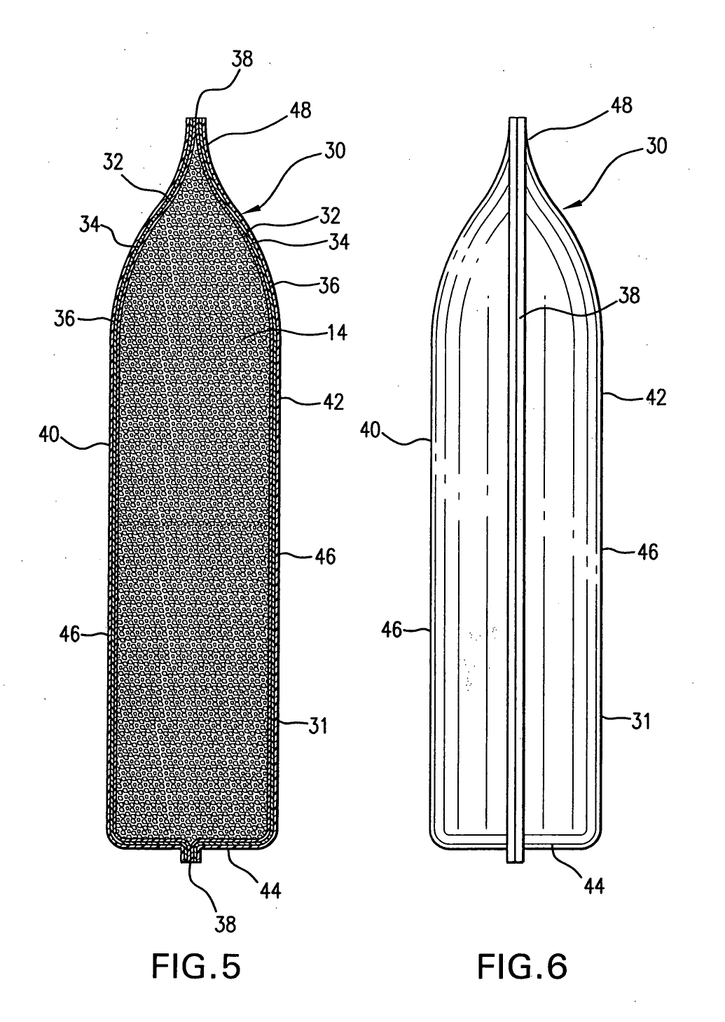

As shown in FIG. 5, the microwaveable bag 31 can be formed of one or more multilayer flexible films or molded parts, each having a first inner layer 32, a second middle layer 34 and a third outer layer 36. The first inner layer 32 can be a heat sealable layer used for forming a heat sealed seam 38 extending around the outer perimeter of the bag 31. Put another way, the microwaveable bag 31 can be formed from two identical flexible film or molded parts 40 and 42 that face each other at their respective heat seal layers 32 and are joined together along seam 38 which extends around a perimeter of bag 31. The first inner layer 32 can be formed of any suitable heat-sealable polymeric material. Examples of heat sealable materials having suitable temperature resistance include without limitation linear low density polyethylene; linear medium density polyethylene; copolymers of polypropylene with up to about 10% by weight ethylene or a C₄-C₂₀ alpha-olefin comonomer; polypropylene which has been impact-modified by blending it with up to about 10% by weight ethylene-propylene diene monomer (“EPDM”), ethylene-propylene rubber (“EPR”) or another compatible elastomeric material; and combinations of the foregoing.

The second middle layer 34 can be a barrier layer that protects the microwaveable bag 31 from penetration by oxygen and/or water vapor when combined with the other layers. The middle layer 34 can be formed from any suitable barrier polymer. Examples of suitable barrier polymers include without limitation polyamides, ethylene-vinyl alcohol, polyvinyl alcohol, polyesters, and combinations thereof. The second middle layer 34 can also be formed from a microwave-safe aluminum foil. One function of the second middle layer 34 is to maintain the stability and consistency of the microwaveable wax composition 14 by preventing excessive infusion of moisture and oxygen during storage, and by maintaining the concentrations of moisture and oxygen inside the bag 31 at consistent and acceptable levels.

The third outer layer 36 can be a high-strength burst resistant layer that prevents the microwaveable bag 31 from rupturing or bursting when exposed to heat and internal pressure caused by the microwave oven. The third outer layer 36 can be formed from any high strength polymeric material. Examples of suitable materials include without limitation polyesters, polyamides, single-site catalyzed (e.g. metallocene-catalyzed) polypropylene, and combinations thereof.

Additional layers and layer combinations may also be employed when making the microwaveable bag 31. The opposing parts 40 and 42 can be formed by cast film coextrusion, blown film coextrusion, thermoforming, or another coextrusion or molding process. The opposing parts 40 and 42 can also be formed as a single part which can be folded over along a fold line to provide mating edges which are then heat sealed together to form a seam.

As shown in FIGS. 5 and 6, the microwaveable bag 31 and, particularly, its opposing parts 40 and 42 are formed and shaped to create a stand-up bag having a base 44, one or more sidewalls 46 and top 48. This allows the microwaveable bag 38 to remain in a standing position during microwave heating of the candlewax 14, if desired for uniform melting of the wax 14. This also allows the microwaveable bag 31 to be placed on a table or counter top in a standing position between pouring of the wax into different candle containers or molds.

As shown in FIG. 4, the microwaveable bag 31 can have a pouring handle 50 extending from the heat seal seam 38 formed in an upper corner 52 of the microwaveable bag 31. The pouring handle 50 can be formed from an extension of the same opposing coextruded parts 40 and 42 that form the microwaveable bag 31. The pouring handle 50 includes a handle opening 54 positioned so that lifting of the bag 31 using the handle 50 causes the bag 31 to tilt in a pouring position. The pouring mechanism 58 is located in the opposing upper corner 56 of the microwaveable bag 31.

The pouring mechanism 58 can be an opening formed in the bag 31 by tearing away or clipping a corner portion 56 of bag 31 along line 60. The line 60 can be a clippable line or tearable line of weakness in the corner 56 of bag 31, including without limitation a die cut line, a laser cut line, a score cut line, a perforation line, a microperforation line, a chemically etched line, a liquid etched line and/or a gas etched line. The line 60 is suitably formed in both opposing portions 40 and 42 of microwaveable bag 31 and extends through the seam 38 so that a portion of corner 56 can be clipped or torn away.

The candle refill kit 30 illustrated in FIG. 4 also includes an attached wick pouch 62 on one side of microwaveable bag 31 that is used for storing wicks to be used when making candles. The wick pouch 62 can be formed between the seam 38 that bounds the microwaveable bag 31 that contains the candlewax 14 and a second outer seam 64 extending from seam 38 at the top 48 and base 44 of bag 31. The wick pouch 62 can be formed between the same two opposing sheets of coextruded material that are used to make opposing parts 40 and 42 of microwaveable bag 31. In order to access and release the wicks from the wick pouch 62, the wick pouch 62 can be separated from the microwaveable bag 31 by tearing along a tear line 66 located just outward of seam 38 and extending between the top 48 and base 44 of microwaveable bag 31. The tear line 66 can be any line of weakness, including without limitation a die cut line, a laser cut line, a score cut line, a perforation line, a microperforation line, a chemically etched line, a liquid etched line and/or a gas etched line. The tear line 66 can be formed on one or both opposing coextruded portions 40 and 42 so that the wick pouch 62 can either remain attached or be completely detached when it is opened.

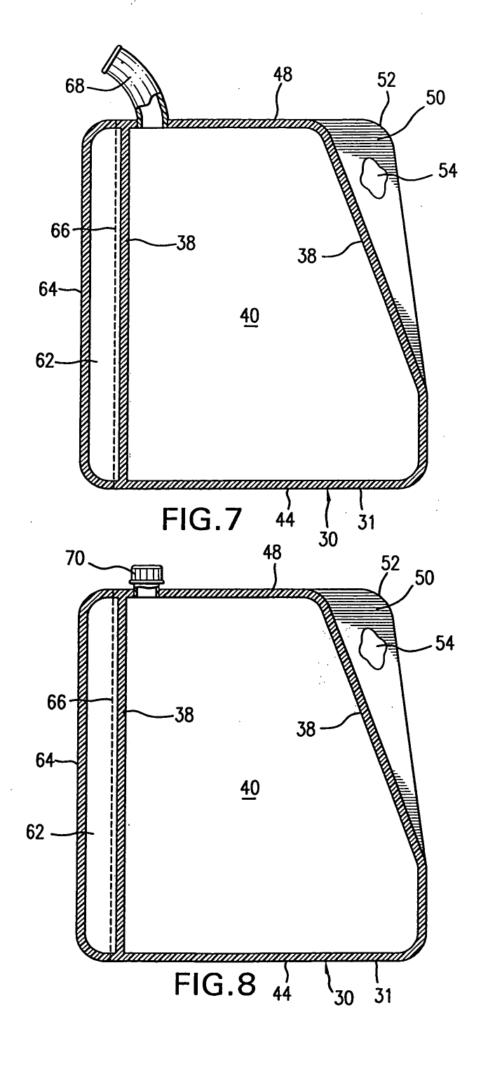

FIGS. 7 and 8 illustrate alternative embodiments of the candle refill kit 30 in which the pouring mechanism 58, instead of being a removable corner, can be an attached opening pouring spout 68 as shown in FIG. 7 or a capped opening 70 with removable cap as shown in FIG. 8. Other variations of pouring mechanism 58 and other variations of pouring handle 50 are also within the scope of this invention. Except for the different pouring mechanisms 58, the candle refill kits 30 shown in FIGS. 7 and 8 are similar to the one shown in FIG. 4.

The candle refill kit of the invention may also include one or more wicks which are selected and/or engineered for compatible burning with the microwaveable candlewax composition. Various wicks are known in the art, and are designed for use with particular types of candlewax. When the candlewax composition is a lipid-based wax composition as described above, the wick may be a flat-braided wick known in the art as “HTP” or “ECO”, or a square-braided wick known in the art as “CD”, or “RRD”. The wick is typically provided separate from the microwaveable candlewax composition. As explained above, in the embodiment of FIGS. 4-8, the wicks can be provided in a detachable portion of the candle refill kit 30, i.e., in a pouch 62 attached to the microwaveable bag 31.

To make the candle refill kit 10 illustrated in FIG. 1, the ingredients of the microwaveable candlewax composition 14 are mixed using conventional methods to form a uniform molten blend or slurry. One or more disposable microwaveable containers 12 are separately formed or provided. The molten candlewax composition is then poured into individual disposable containers 12 and permitted or caused to cool and harden. For the candlewax compositions based on lipid-based waxes, described above, the ingredients should be mixed at about 35° C. or greater, suitably about 35-95° C., particularly about 55-85° C. The initial mixing step can be performed using any suitable batch or continuous mixer, including without limitation a Hobart mixer or a stirred kettle equipped with a steam heat exchanger. The amount of molten candlewax poured into each disposable container 12 can be precisely controlled according to a predetermined amount by monitoring the weight of the filled container or the depth of the candlewax fill.

In an alternative embodiment, the molten candlewax blend may be prepared at a first temperature of at least about 35° C., suitably about 50-95° C., particularly about 55-85° C. Then, the molten blend is rapidly cooled to a second (sub-molten) temperature less than about 50° C., suitably about 25-40° C., particularly about 30-38° C., and is slowly agitated at the second temperature to form a slurry or magma of fine wax crystals. The mild agitation should occur for a long enough time period to homogenize the slurry or magma, and to achieve a uniform and stable crystal form. The slurry or magma (at the second temperature) can then be poured into the disposable containers 12, and permitted to cool and harden. Candles made by this technique have more uniform crystallization and burning properties, and better retention of scenting agents and other volatile ingredients.

Rapid cooling of the molten candlewax from the first temperature to the second temperature can be accomplished by passing the candlewax through a swept-surface heat exchanger. A suitable swept-surface heat exchanger is a commercially available Votator A Unit, described in more detail in U.S. Pat. No. 3,011,896, which is incorporated by reference. A Votator A Unit includes an internally refrigerated, elongated cylinder equipped with a sweeping device. Molten wax enters the unit and quickly forms crystals, which are continuously removed from the cylinder walls. Cooling can be provided by feeding a suitable cooling fluid, such as expanding ammonia, through a jacket surrounding the cylinder.

The chilled candlewax composition can then be passed to a holding tank equipped with an agitation mechanism, for mildly agitating and working the composition at about the second temperature until a candlewax composition having the desired consistency, crystal stability and homogeneity is obtained. A suitable holding tank for agitating the composition is a Votator B Unit, also described in U.S. Pat. No. 3,011,896. The Votator B Unit is an elongated cylindrical chamber in series with the Votator A Unit. The Votator B Unit includes a rotating shaft having projecting fingers intermeshing with stationary fingers projecting from the inner cylinder wall, to provide agitation. Crystal formation and modification occur under virtually adiabatic conditions in the Votator B Unit.

The Votator A and Votator B Units can be formed of stainless steel, with inlets and outlets at their bases. The units are further described in U.S. Pat. No. 1,783,864 and U.S. Reissue Pat. 21,406, which are incorporated by reference. The rapid cooling followed by mild agitation described above are collectively referred to as “votating” the candlewax composition. The composition thus formed is a “votated” candlewax composition.

To prepare a candle using the candle refill kit 10 illustrated in FIG. 1 or the candle refill kit 30 illustrated in FIGS. 4-8, the disposable microwaveable container 12 or flexible bag 31 filled with candlewax composition 14 is placed into a microwave oven and heated to a temperature sufficient to initiate pouring of the candlewax composition. The candlewax composition 14 will then require heating to a molten temperature of at least about 35° C., suitably about 50-95° C., particularly about 55-80° C. before pouring can be initiated. In the embodiment illustrated in FIG. 3, the container 12 is initially pre-filled with a microwaveable candlewax composition 14 and sealed closed with lid 15. The user needs only to open and remove lid 15 using pop-up tab 17, and install outer cover 19 before placing the container 12 in a microwave oven. The openings 21 in cover 19 prevent pressure build-up, while cover 19 prevents boil-over and excessive escape of scenting agents.

When the flexible bag 31 of FIGS. 4-6 is used as the disposable microwaveable container, the bag 31 is pre-filled with a microwaveable candlewax composition 14 and sealed with the tearable corner 56 intact. The bag 31 is placed in a microwave oven and the candlewax composition 14 is heated to the foregoing molten temperatures. By keeping the corner 56 intact and the bag 31 sealed during heating, any scenting agent or fragrance in the candlewax composition 14 is prevented from escaping and saturating the microwave oven. Once the heating is completed, the pre-filled bag 31 is removed from the microwave oven and the tearable corner 56 is removed to facilitate pouring of the candlewax composition 14. Prior to pouring the candlewax composition, the wick pouch 62 may be separated from the flexible bag 31 along tearable line 66. A wick can then be removed from the wick pouch 62 and inserted and positioned within the candle mold or container. The molten candlewax composition 14 is then poured into the candle mold or container with the wick in place, and is cooled or permitted to cool.

The candle refill kit 10 or 30 preferably includes specific microwaving instructions for obtaining a pourable candlewax composition. Required microwave times are typically not more than about five minutes, but may vary from less than one minute to 10 minutes or more depending on the volume of candlewax composition 14, the melting point of the candlewax composition 14, whether or not the candlewax composition was votated, and the size and heating power of the microwave oven. Because microwave heating times are much shorter than heating times previously required in conventional ovens, there is minimal escape of scenting agents or other volatile ingredients, and minimal degradation of temperature-sensitive ingredients, and increased safety. For this reason, it is permissible to heat all of the candlewax ingredients together in the microwave oven for the same length of time. The complex techniques of separate addition and blending of ingredients, associated with the longer heating times of conventional stoves with double boilers are thus avoided.

In one embodiment, the coloring agent(s), scenting agent(s) or both are provided in one or more separate packets. The microwaveable candlewax composition 14 in container 12 or flexible bag 31 is heated to a molten state. The coloring and/or scenting agents are then added and mixed into the candlewax composition 14. This approach is beneficial because it minimizes the escape of scenting agents due to heating, and minimizes the discoloration of coloring agents.

To make a stand-alone candle, the molten candlewax composition 14 is poured from container 12 or flexible bag 31 into a conventional candle mold equipped with a standing wick, and is cooled or permitted to cool. The resulting candle is released from the mold. To make a container candle, the molten candlewax composition 14 is poured into a candle container equipped with a standing wick, and is cooled or permitted to cool, forming the candle. This enables the use of attractive candle containers which are new, as well as the recycling of candle containers which have previously been used. The candle container may be a new or recycled jar, cylinder, tube, or other suitable container. In either case, the wick should be centered and maintained upright while the wax composition is being poured. Once the microwaveable candlewax composition 14 has been poured, the disposable microwaveable container 12 or flexible bag 31 can be discarded or recycled. The candle refill kit 10 of the invention is useful as a refill kit for all candle containers.

To make the candle refill kit 20 illustrated in FIG. 2, the ingredients of candlewax composition 24 are first melted and blended to form a uniform composition, using a conventional technique as described above for candlewax composition 14. One or more disposable microwaveable containers 22 are separately formed or provided. Then, in one embodiment, the molten candlewax composition is cooled, hardened and formed into granules, flakes, beads or pastilles (collectively “particles”). A predetermined volume or weight of candlewax composition, sufficient to fill a disposable container 22 to a desired level, is deposited and stored in a separate packet 28 which can be formed of plastic film or paper. In another embodiment, the molten candlewax composition is instead formed into slugs of predetermined volume or weight. A candlewax slug is cooled, deposited and stored in the packet 28. In still another embodiment, the molten candlewax composition 24 is rapidly cooled to a second temperature and votated as described above for candlewax composition 14. The magma or slurry of votated candlewax composition 24 is poured, in a predetermined amount, into packet 28 for storage. The votated composition then cools and hardens into a slug. In any of these embodiments, the coloring and/or scenting agents may alternatively be provided in one or more separate packets as described above.

To prepare a candle using the candle refill kit 20 illustrated in FIG. 2, the user opens the packet 28 and transfers the particles or slug of candlewax composition 24 into the disposable microwaveable container 22. From that point forward, the method steps for preparing a candle using kit 20 are identical to the method steps for preparing a candle using kit 10, described above. The disposable microwaveable container 22 filled with candlewax composition 24 is heated in a microwave oven and then poured into a candle mold or candle container equipped with a standing wick. If the candlewax composition 24 was solidified from a molten state before being stored in packet 28, then it should be heated back to the molten state in the microwave oven before being poured from the disposable container 22. If the coloring and/or scenting agents are provided in separate packets, they can then be added and mixed with the molten candlewax composition 14.

In one embodiment, the microwaveable candle container 12 or 22 or flexible bag 31 can be provided with a color-changing strip (not shown) on an internal surface, which changes color when the candlewax composition 14 or 24 reaches a desired temperature in the container. If the container is transparent, the color-changing strip will advise the user when the candlewax composition 14 is sufficiently heated.

While the embodiments of the invention described herein are presently preferred, various modifications and improvements can be made without departing from the spirit and scope of the invention. The scope of the invention is indicated by the appended claims, and all changes that fall within the meaning and range of equivalents are intended to be embraced therein.

I claim:

1. A candle refill kit, comprising:
a disposable microwaveable container; and
a microwaveable candlewax composition;
wherein the disposable microwaveable container comprises a flexible bag.

2. The candle refill kit of claim 1, wherein the flexible bag is a stand-up bag including a base, one or more sidewalls, and a top.

3. The candle refill kit of claim 1, wherein the flexible bag comprises two opposing coextruded parts joined together along a seam.

4. The candle refill kit of claim 1, wherein the flexible bag comprises a single coextruded part folded over along a fold line to provide mating edges which are joined together to form a seam.

5. The candle refill kit of claim 1, wherein the flexible comprises a first inner heat seal layer, a second middle barrier layer, and a third outer high-strength burst-resistant layer.

6. The candle refill kit of claim 1, wherein the flexible bag comprises a retort bag.

7. The candle refill kit of claim 2, wherein the flexible bag further comprises a handle and a pouring mechanism.

8. The candle refill kit of claim 1, wherein the microwaveable candlewax composition comprises a lipid-based wax.

9. The candle refill kit of claim 1, wherein the microwaveable candlewax composition comprises:
at least about 25% by weight of a plant-based wax;
about 1-50% by weight of a polyol fatty acid partial ester;
about 1-50% by weight of a free fatty acid;
about 0.1-15% by weight of a scenting agent; and
about 0-8% by weight of a coloring agent.

10. The candle refill kit of claim 9, wherein the microwaveable candlewax composition comprises:
about 50-98% by weight of the plant-based wax; and
about 10-35% by weight of the polyol fatty aid partial ester.

11. A candle refill kit, comprising:
a disposable microwaveable container; and
a microwaveable candlewax composition;
wherein the disposable microwaveable container comprises a flexible bag including a handle and a pouring mechanism.

12. The candle refill kit of claim 11, wherein the pouring mechanism comprises a removable corner in the flexible bag.

13. The candle refill kit of claim 11, wherein the flexible bag comprises a stand-up bag including a base, one or more sidewalls, and a top.

14. The candle refill kit of claim 11, further comprising a wick pouch attached to the flexible bag, the wick pouch including a plurality of wicks.

15. The candle refill kit of claim 14, wherein the flexible bag and the wick pouch are formed between two opposing coextruded parts that are joined together by first and second heat sealed seams, the first heat sealed seam extending around a perimeter of the flexible bag, the second heat sealed seam extending from the first heat sealed seam, the wick pouch being formed between the first and second heat sealed seams.

16. A candle refill kit, comprising:
a disposable microwaveable container; and
a microwaveable candlewax composition;
wherein the disposable microwaveable container comprises a flexible stand-up bag including a base, one or more sidewalls and a top, the bag further including a handle and a pouring mechanism.

17. The candle refill kit of claim 16, wherein the pouring mechanism is selected from the group consisting of a removable corner on the bag, a spout, and a capped opening.

18. The candle refill kit of claim 16, wherein the flexible bag comprises two opposing coextruded parts joined together along a seam.

19. The candle refill kit of claim 16, wherein the flexible bag comprises a single coextruded part folded over along a fold line to provide mating edges which are joined together to form a seam.

20. The candle refill kit of claim 16, further comprising a wick pouch attached to the flexible bag.

21. A method of preparing a candle, comprising the steps of:
providing a candle refill kit including a sealed microwaveable flexible bag and a microwaveable candlewax composition within the flexible bag;
heating the candle refill kit in a microwave oven until the microwaveable candlewax composition reaches an elevated molten temperature within the flexible bag;
removing a corner portion from the flexible bag to form an opening;
pouring the candlewax composition from the flexible bag into a candle mold or candle container; and
cooling the candlewax composition or permitting it to cool.

22. The method of claim 21, wherein the flexible bag is a stand-up bag including a base, one or more sidewalls, and a top.

23. The method of claim 22, wherein the flexible bag further comprises a handle.

24. The method of claim 21, wherein the corner portion is removed from the flexible bag after the candle refill kit is heated.

25. The method of claim 21, wherein the candle refill kit includes a wick pouch attached to the flexible bag, further comprising the step of removing a wick from the wick pouch and inserting the wick into the candle container or mold.
